(19) United States
(12) Patent Application Publication
(10) Pub. No.: US 2011/0138288 A1
(43) Pub. Date: Jun. 9, 2011

(54) METHOD, SYSTEM, AND COMPUTER PROGRAM PRODUCT FOR TAGGING OF PORTLETS IN A PORTAL INFRASTRUCTURE

(75) Inventors: Daniel Blum, Stuttgart (DE); Jan P. Buchwald, Boeblingen (DE); Richard Jacob, Ostfildern (DE); Timo Kussmaul, Boeblingen (DE); Oliver Then, Aidlingen (DE)

(73) Assignee: International Business Machines Corporation, Armonk, NY (US)

(21) Appl. No.: 12/894,113

(22) Filed: Sep. 29, 2010

(30) Foreign Application Priority Data
Dec. 8, 2009 (DE) 09178324.1

(51) Int. Cl. G06F 15/16; G06F 3/048

(52) U.S. Cl. 715/733

(57) ABSTRACT

A method for tagging of portlets in a portal infrastructure includes: receiving by at least one consumer system from at least one client system tagging information related to remote portlets produced by at least one producer system; sending by the at least one consumer system the tagging information related to the remote portlets to the at least one producer system that produced the remote portlets, where the at least one producer system uses the tagging information related to the remote portlets to update global tag sets for the remote portlets; receiving by the at least one consumer system the updated global tag sets from the at least one producer system; and creating by the at least one consumer system a response to a request for portal pages comprising the remote portlets from the at least one client system using the received updated global tag sets.

### CROSS-REFERENCE TO RELATED APPLICATIONS

The present application claims priority to European Patent Application No. 09178324.1, filed on Dec. 8, 2009.

### BACKGROUND

1. Field of the Invention

The present invention relates in general to the field of web-based applications that include remote portlets, and in particular to a method and a system for tagging of portlets in a portal infrastructure. Still more particularly, the present invention relates to a computer program product for performing the tagging of portlets in a portal infrastructure.

2. Description of the Related Art

Web-based applications have become very popular. One type of web-based application may be created using the Web Services for Remote Portlets (WSRP) standard. According to the WSRP standard, producers host portlets that perform various functions, and provide those portlets to consumers using a web service interface. Consumers integrate portlets provided by a producer as remote portlets, such that they can be used as if deployed locally. Users access the remote portlets in the context of portal pages or applications from the consumers. The WSRP standard basically defines the web service interface for the communication of consumers and producers to allow interoperability between different suppliers.

Portals provide end users with unified access to content, applications, and collaboration services in a highly personalized manner. An example is IBM's WebSphere Portal™ which provides a middleware framework and tools for building and managing portals using component applications called “portlets”.

Typically a portal employs an architecture where the Portal itself only implements standard functionality like authentication, state handling, aggregation, caching, user management, and so on and provides the infrastructure for application components. This architecture includes APIs (Application Programming Interface) for the integration of applications so that applications from different partners can be used as long as they match the portal product's API. In the portal environment, these applications are typically called portlets.

Portlets are pluggable components that can be added to portals and are designed to run inside a portal's portlet container. Portlets may provide different functions ranging from simple rendering of static or dynamic content to application functions such as e-mail, calendar, etc. Portlets are invoked indirectly via the portal application and produce content that is suited for aggregation in larger pages, e.g., portlets should produce mark-up fragments adhering to guidelines that assure that the content generated by different portlets can be aggregated into one page. Typically, portlets run on a portal-server, processing input data and rendering content locally.

A portal, as e.g., represented by above IBM WebSphere Portal™, is built by a complex functionality implemented on a network server, for example a web server, which has elements including logic components for user authentication, state handling, aggregation of fragments, a plurality of portlets provided in respective pages with a respective plurality of APIs to a respective portlet container software for setting them into the common web page context, and some portal storage resources. The logic components are operatively connected such that data can be exchanged between single components as required.

In the Patent Application Publication US 2006/0085500 A1 “Message interface for configuring web services for remote portlets” by Allamaraju et al., a web service system is disclosed. The disclosed web service system enables web servers to serve pages that utilize remote portlets stored on remote systems. A consumer system serves pages that utilize remote portlets stored on one or more producer systems. When a user system accesses a page utilizing a remote portlet through a web browser, the consumer system contacts the producer system, obtains content for the page and delivers the page to the user system. Information for configuring the consumer system to utilize the portlets on the producer system can be transmitted with the aid of a graphical interface that enables a user to send configuration information through electronic mail. The consumer system is a network accessible system that serves web pages, content, and applications to other parties. The consumer can serve its own content in addition to content stored on the producer systems. The consumer system presents a web interface to the user systems that utilizes applications stored both locally and on the producer systems. The consumer system serves pages that utilize remote portlets on the producers through proxy portlets and allow the consumer to utilize the remote portlets' functionality. The proxy portlets are references to remote portlets that are stored within the web pages on the consumer that cause the portlets to appear within the consumer web pages. During a registration phase, the consumer registers with a producer identifying each consumer with a unique handle that enables the producer to identify what portlets are available to a particular consumer. In some embodiments, the consumer does not register with the producer. The producer can provide a service description to the consumer that indicates properties of the producer and lists the available portlets that are stored on the producer. During a description phase, the producer also provides a Web Services Description Language (WSDL) file indicating data types and message protocols to be used for interacting with the producer. A service description handler, through the producer core returns to the consumer a list of available portlets in the form of an array of portlet definition classes or some other format. The portlet definition classes include a portlet handle identifier that identifies the portlet and modes, states, MIME types, a title, and a description for each portlet. Other information can also be provided. When a request from a user system is received at the consumer, for example, a page is loaded that utilizes a remote portlet, the consumer requests the appropriate render data from the producer. This request includes an identity of the portlet and a listing of capabilities of the user system. The markup handler receives this request and determines an appropriate portlet adapter to access the referenced portlet.

In the Patent Application Publication US 2007/0005733 A1 “System and method for a web service portlet registry” by Allamaraju et al., a web service system is disclosed. The disclosed web service system comprises a service portlet registry enabling organization and implementation of portlets for a producer system. A producer system makes one or more portlets accessible for utilization by remote consumers. A portlet registry is generated that enables searching and accessing portlets across a wide variety of producer systems. Each producer generates a registry of portlets that are accessible and can publish the registry as a web service. The registry is made accessible via protocols that allow it to be accessed by remote consumers. A remote consumer can then search across multiple producers by utilizing the registry. This enables the consumers to find producers and portlets based on search criteria. A registry server maintains the portlet registry in the form of a relational database, for example. The registry server can be a separate server or a module running on a web server. The database typically includes a series of portlet entries. Each of the portlet entries includes metadata associated with the portlet. The metadata includes a variety of descriptive information associated with the portlet. Such information can include an identifier for the portlet, a description of the portlet, an access point for the portlet, a reference to the producer maintaining the portlet, and various arbitrary metadata. A consumer admin system can submit a search request to the registry server. The search request can include descriptive information for the portlets, identifiers, or any information that a searcher might employ when looking for a portlet. The registry server matches this information against the metadata for portlets stored within the database and returns any matches. A user of the consumer admin system can retrieve information for configuring the returned portlets as remote portlets by selecting the returned results. A search module searches the database against the search terms and returns any portlets having metadata matching the search terms. The search module usually returns the metadata for the portlets, including configuration information for utilizing the portlets as remote portlets. This configuration information can include an identifier for the producer, an identifier for the portlet, and any other relevant information. In some embodiments, the search module includes a server for generating a web interface that accepts the search terms. In alternate embodiment, it interacts with an existing server.

A problem with current web-based applications using remote portlets is that metadata and/or tagging information are given from the producer systems and were not created by a user system.

### BRIEF SUMMARY

According to one embodiment of the present invention, a method for tagging of portlets in a portal infrastructure comprises: receiving by at least one consumer system from at least one client system tagging information related to remote portlets produced by at least one producer system; sending by the at least one consumer system the tagging information related to the remote portlets to the at least one producer system that produced the remote portlets, wherein the at least one producer system uses the tagging information related to the remote portlets to update global tag sets for the remote portlets; receiving by the at least one consumer system the updated global tag sets from the at least one producer system; and creating by the at least one consumer system a response to a request for portal pages comprising the remote portlets from the at least one client system using the received updated global tag sets.

In one aspect of the present invention, the portal pages further comprise local portlets produced by the at least one consumer system, wherein the receiving by the at least one consumer system from the at least one client system the tagging information related to the remote portlets, and the creating by the at least one consumer system the response to the request for the portal pages comprising the remote portlets from the at least one client system using the updated global tag sets, comprise: receiving by the at least one consumer system from the at least one client system tagging information related to the local portlets; updating by the at least one consumer system local tag sets for the local portlets using the tagging information related to the local portlets; and creating by the at least one consumer system the response to the request for the portal pages comprising the remote portlets and the local portlets using the received updated global tag sets and the updated local tag sets.

In one aspect of the present invention, the sending by the at least one consumer system the tagging information related to the remote portlets to the at least one producer system that produced the remote portlets, further comprises: updating by the at least one producer system a global tag database comprising the global tag sets for the remote portlets produced by the at least one producer system.

In one aspect of the present invention, the updating by the at least one consumer system the local tag sets for the local portlets using the tagging information related to the local portlets, further comprises: updating by the at least one consumer system a local tag database comprising the local tag sets for the local portlets produced by the at least one consumer system.

In one aspect of the present invention, the updating by the at least one producer system the global tag database comprising the updated global tag sets for the remote portlets produced by the at least one producer system comprises: receiving by the at least one producer system tag statistics related to the remote portlets produced by the at least one producer system from the at least one consumer system; and incorporating the tag statistics related to the remote portlets produced by the at least one producer system into the global tag database by the at least one producer system.

In one aspect of the present invention, the updating by the at least one consumer system the local tag database comprising the updated local tag sets for the local portlets produced by the at least one consumer system comprises: incorporating tag statistics related to the local portlets produced by the at least one consumer system into the local tag database by the at least one consumer system.

In one aspect of the present invention, the incorporating the tag statistics related to the local portlets produced by the at least one consumer system into the local tag database by the at least one consumer system comprises: counting and aggregating tagging actions of the at least one client system related to the local portlets and the remote portlets; and reporting the tagging actions related to the remote portlets to the at least one producer system producing the remote portlets.

In one aspect of the present invention, the method further comprises: prioritizing by the consumer system the tag information of the global tag sets using the tag statistics related to the remote portlets; and prioritizing by the consumer system the tag information of the local tag sets using the tag statistics related to the local portlets.

In one aspect of the present invention, the creating by the at least one consumer system the response to the request for the portal pages comprising the remote portlets, further comprises: creating by the at least one consumer system the response to the request for the portal pages from the at least one client system using the prioritized tag statistics related to the remote portlets and the prioritized tag statistics related to the local portlets.

In one aspect of the present invention, the tagging information of the global tag sets and the local tag sets used on the portal pages are displayed at the at least one client system using the remote portlets and the local portlets according their prioritization.

System and computer program products corresponding to the above-summarized methods are also described and claimed herein.

### BRIEF DESCRIPTION OF THE DRAWINGS

FIG. 1 is a schematic block diagram of a system for tagging of portlets in a portal infrastructure, in accordance with an embodiment of the present invention; and

FIG. 2 is a schematic flow chart of a method for tagging of portlets in a portal infrastructure, in accordance with an embodiment of the present invention.

### DETAILED DESCRIPTION

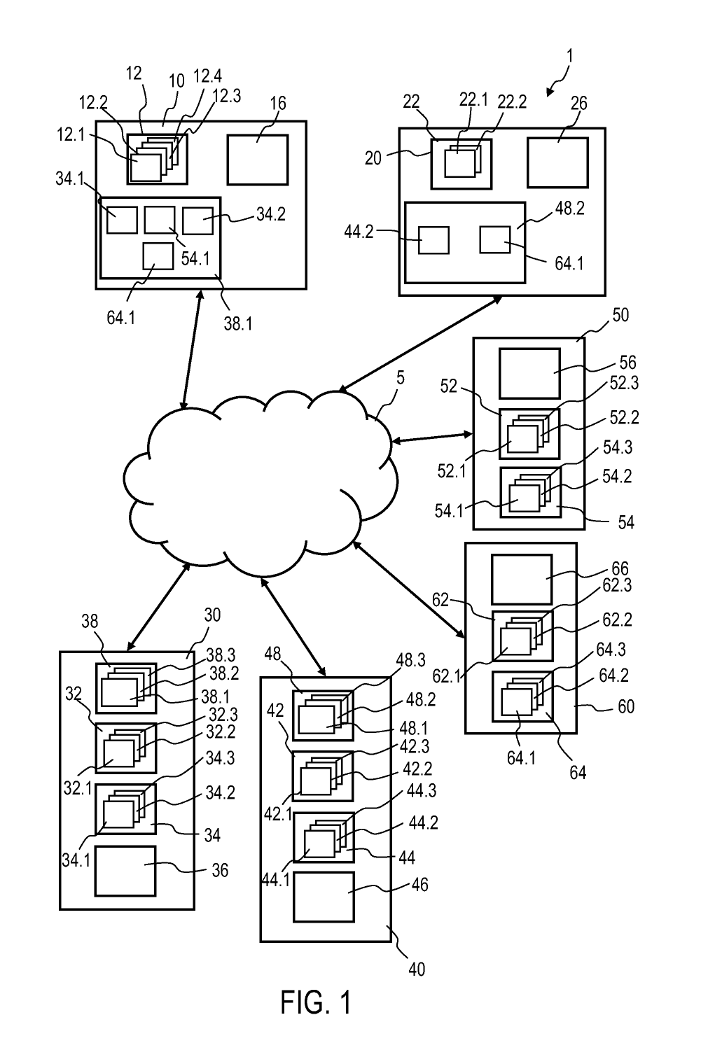

FIG. 1 is a schematic block diagram of a system for tagging of portlets in a portal infrastructure, in accordance with an embodiment of the present invention.

Referring to FIG. 1, the shown embodiment of the present invention employs a system for tagging of portlets 34.1, 34.2, 34.3, 44.1, 44.2, 44.3, 54.1, 54.2, 54.3, 64.1, 64.2, 64.3 in a portal infrastructure 1 comprising a communication network 5, at least one client system 10, 20 or end user systems, at least one consumer system 30, 40, and at least one producer system 50, 60. Only two client systems 10, 20, two consumer systems 30, 40 and two producer systems 50, 60 are shown to ease the description.

The client systems 10, 20 are requesting and displaying portal pages 38.1, 38.2, 38.3, 48.1, 48.2, 48.3 from the consumer systems 30, 40. The portal pages 38.1, 38.2, 38.3, 48.1, 48.2, 48.3 created by the consumer systems 30, 40 comprise at least one portlet 34.1, 34.2, 34.3, 44.1, 44.2, 44.3, 54.1, 54.2, 54.3, 64.1, 64.2, 64.3. The consumer systems 30, 40 receive the requests of the client systems 10, 20, invoke local portlets 34.1, 34.2, 34.3, 44.1, 44.2, 44.3 and/or remote portlets 54.1, 54.2, 54.3, 64.1, 64.2, 64.3 produced by the producer systems 50, 60 and transfer at least one portal page 38.1, 38.2, 38.3, 48.1, 48.2, 48.3 to the client systems 10, 20 to answer the requests. The producer systems 50, 60 produce the remote portlets 54.1, 54.2, 54.3, 64.1, 64.2, 64.3 and provide the remote portlets 54.1, 54.2, 54.3, 64.1, 64.2, 64.3 to the corresponding consumer system 30, 40 via a remote protocol.

According to an embodiment of the present invention, at least one producer system 50, 60 is extended by a tagging engine 56, 66 receiving tag information created by the client systems 10, 20 from the consumer systems 30, 40 via an extended remote protocol, wherein the tagging engine 56, 66 is creating and/or updating a global tag database 52, 62 comprising a global tag set 52.1, 52.2, 52.3, 62.1, 62.2, 62.3 for each remote portlet 54.1, 54.2, 54.3, 64.1, 64.2, 64.3 and providing the global tag sets 52.1, 52.2, 52.3, 62.1, 62.2, 62.3 to the corresponding consumer system 30, 40 via the extended remote protocol. The consumer systems 30, 40 use the global tag sets 52.1, 52.2, 52.3, 62.1, 62.2, 62.3 to create a response to the client systems 10, 20.

Additionally, the consumer systems 30, 40 are also extended by a tagging engine 36, 46 receiving tagging information related to a local portlet 34.1, 34.2, 34.3, 44.1, 44.2, 44.3 and created by the client systems 10, 20 via a standard protocol. The corresponding tagging engine 36, 46 is creating and/or updating a local tag database 32, 32 comprising a local tag set 32.1, 32.2, 32.3, 42.1, 42.2, 42.3 for each local portlet 34.1, 34.2, 34.3, 44.1, 44.2, 44.3 produced by the corresponding consumer system 30, 40. The consumer systems 30, 40 use the local tag sets 32.1, 32.2, 32.3, 42.1, 42.2, 42.3 to create the response to the requesting client system 10, 20. The client systems 10, 20 also comprise tagging engines 16, 26 to create the tagging information related to local portlets 34.1, 34.2, 34.3, 44.1, 44.2, 44.3 and/or remote portlets 54.1, 54.2, 54.3, 64.1, 64.2, 64.3.

A typical portal created by the consumer systems 30, 40 provides access to user specific information, applications and processes using local and remote information sources. It combines the aggregated applications and provides a unified presentation layer. The portal implementation provides a component model that allows plugging components referred to as portlets 34.1, 34.2, 34.3, 44.1, 44.2, 44.3, 54.1, 54.2, 54.3, 64.1, 64.2, 64.3 into the portal infrastructure 1. The portlets 34.1, 34.2, 34.3, 44.1, 44.2, 44.3, 54.1, 54.2, 54.3, 64.1, 64.2, 64.3 are user-facing interactive web applications that render markup fragments. The content of a portlet is normally aggregated with content from other portlets to form the portal pages 38.1, 38.2, 38.3, 48.1, 48.2, 48.3.

Besides local portlets 34.1, 34.2, 34.3, 44.1, 44.2, 44.3 locally executed on the portal system, another standard named WSRP (Web Services for Remote Portlets) introduces a mechanism that allows dynamic integration of remote portlets 54.1, 54.2, 54.3, 64.1, 64.2, 64.3 executed on remote portal systems, so called WSRP producer systems 50, 60, into other WSRP consumer systems 30, 40. The remote portlets 54.1, 54.2, 54.3, 64.1, 64.2, 64.3 also provide markup fragments that combine data and presentation logic and that can be aggregated together with the local portlets 34.1, 34.2, 34.3, 44.1, 44.2, 44.3 to form the content of a portal page 38.1, 38.2, 38.3, 48.1, 48.2, 48.3. Usually the consumer systems 30, 40 communicate with the WSRP remote portlets 54.1, 54.2, 54.3, 64.1, 64.2, 64.3 using generic proxy portlets. Common advantages of remote portlets 54.1, 54.2, 54.3, 64.1, 64.2, 64.3 include aspects like integration of portlets across borders of different vendors portals independently of the technology used for the implementation and isolation of execution of portlets.

The portal infrastructure 1 uses tagging engines 16, 26, 36, 46, 56, 66 to allow users to tag entities like forum threads, blog articles, images in galleries, local portlets 34.1, 34.2, 34.3, 44.1, 44.2, 44.3 or remote portlets 54.1, 54.2, 54.3, 64.1, 64.2, 64.3 with keywords. This way user can find content in a web site/portal based on their keywords. With related web and/or collaboration technologies, web sites and portals enable collaborative tagging, allowing users to tag the above mentioned entities and share them across the user space, i.e. users can find relevant content based on the tagging of other users and utilize so called tag clouds or tag sets 12.1, 12.2, 12.3, 12.4, 22.1, 22.2, 32.1, 32.2, 32.3, 42.1, 42.2, 42.3, 52.1, 52.2, 52.3, 62.1, 62.2, 62.3 to see the relevance of an entity relative to the used keywords.

In the shown distributed environment 1 using the remote portlet technology, WSRP producer systems 50, 60 can provide remote portlets 54.1, 54.2, 54.3, 64.1, 64.2, 64.3 as a service to WSRP consumer systems 30, 40. In such an environment the WSRP producer systems 50, 60 can be viewed as a software service host, running the application logic, the data layer and providing the presentation layer to the WSRP consumer systems 30, 40. User systems 10, 20 can interact with the provided portlet presentation layer and trigger action and events which result in application logic execution and state changes. Producer systems 50, 60 can serve a multitude of consumer systems 30, 40 providing the same service to those consumer systems 30, 40.

In an existing WSRP consumer system, portals are the entry point for the end users and interact independently of other consumer systems, i.e. they provide an isolated environment and user space. From a user's perspective each consumer system portal is a separate, independent web site providing certain service for its end-users. The drawback is that although the WSRP consumer system portals use the same service/remote portlets provided by a WSRP producer system, there is no link or collaboration between these.

The embodiments of the present invention are combining the existing portal technologies using WSRP for integrating content into portals with the collaborative tagging engine approach to enrich the collaborative end-user experience of WSRP consumer systems 30, 40 using the same set of services from a WSRP producer system 50, 60. This way a more collaborative mash up of user recommendations, tags, and tag clouds or tag sets 12.1, 12.2, 12.3, 12.4, 22.1, 22.2, 32.1, 32.2, 32.3, 42.1, 42.2, 42.3, 52.1, 52.2, 52.3, 62.1, 62.2, 62.3, which can be utilized to make WSRP consumer systems 30, 40 profit from interactions with the remote service of other consumers and/or users.

Embodiments of the present invention introduce a concept of a shared/distributed system in which tags set on remote portlet entities by users of WSRP consumer systems 30, 40 are communicated back to the WSRP producer system 50, 60 and distributed back to other consumer systems 30, 40 using the same remote portlet. The producer systems are enhanced to maintain a tag store accumulating all tag entries made by users interacting with the WSRP Consumer systems. The WSRP protocol is extended to allow consumer systems 30, 40 to retrieve metadata about tags set on portlets, to communicate tagging actions of their user systems 10, 20 back to the producer systems 50, 60 and to retrieve the up-to-date tag cloud or tag set for a remote portlet. This way the user spaces, in regards to tagging, of different WSRP consumer systems become a centralized/common user space sharing the collaborative tagging knowledge of all user systems 10, 20 across consumer boundaries.

In the shown embodiment, the producer systems 50, 60 and/or the consumer systems 30, 40 are incorporating tag statistics into their global tag database 52, 62 and/or local tag database 32, 42. To incorporate tag statistics, the consumer systems 30, 40 are counting and aggregating tagging actions of corresponding client systems 10, 20 related to local portlets 34.1, 34.2, 34.3, 44.1, 44.2, 44.3 and/or remote portlets 54.1, 54.2, 54.3, 64.1, 64.2, 64.3. Then the consumer systems 30, 40 are reporting the counted and aggregated tagging actions of remote portlets 54.1, 54.2, 54.3, 64.1, 64.2, 64.3 to the related producer systems 50, 60.

In the shown embodiment a first client system 10 is showing a first portal page 38.1 created by a portal page engine 38 of a first consumer system 30. Additionally, the first consumer system 30 is providing additional portal pages 38.2, 38.3 created by the portal page engine 38. The first client system 10 comprises a tag database 12 in which actual tag sets 12.1, 12.2, 12.3, 12.4 of the portlets 34.1, 34.2, 54.1, 64.1 used by the first portal page 38.1 are stored. Here the local portlets 34.1, 34.2 are created by the first consumer system 30, the remote portlet 54.1 is created by a first producer system 50 and the remote portlet 64.1 is created by a second producer system 60.

A second client systems 20 is showing a second portal page 48.2 created by a portal page engine 48 of a second consumer system 40. Additionally, the second consumer system 40 is providing additional portal pages 48.1, 48.3 created by the portal page engine 48. The second client system 20 comprises a tag database 22 in which actual tag sets 22.1, 22.2 of the portlets 44.2, 64.1 used by the second portal page 48.2 are stored. Here the local portlet 44.2 is created by the second consumer system 40 and the remote portlet 64.1 is created by the second producer system 60.

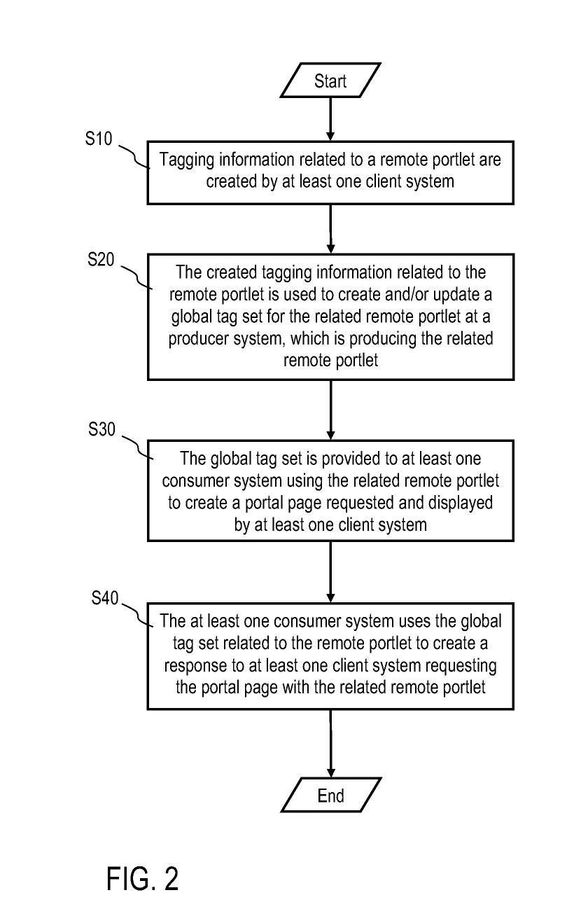

FIG. 2 is a schematic flow chart of a method for tagging of portlets in a portal infrastructure, in accordance with an embodiment of the present invention.

Referring to FIG. 2, the shown embodiment of the invention employs a method for tagging of portlets 34.1, 34.2, 34.3, 44.1, 44.2, 44.3, 54.1, 54.2, 54.3, 64.1, 64.2, 64.3 in the portal infrastructure 1 shown in FIG. 1. In a step S10 tagging information related to a remote portlet 54.1, 54.2, 54.3, 64.1, 64.2, 64.3 is created by the at least one client system 10, 20, using the tagging engines 16, 26, for example. According to step S20 the created tagging information related to the remote portlets 54.1, 54.2, 54.3, 64.1, 64.2, 64.3 are used to create and/or update a global tag set 52.1, 52.2, 52.3, 62.1, 62.2, 62.3 for the remote portlet 54.1, 54.2, 54.3, 64.1, 64.2, 64.3 at corresponding producer system 50, 60, which is producing the remote portlets 54.1, 54.2, 54.3, 64.1, 64.2, 64.3. In step S30 the global tag sets 52.1, 52.2, 52.3, 62.1, 62.2, 62.3 relating to the remote portlets 54.1, 54.2, 54.3, 64.1, 64.2, 64.3 are provided to the consumer systems 30, 40 using the related remote portlets 54.1, 54.2, 54.3, 64.1, 64.2, 64.3 to create the portal pages 38.1, 38.2, 38.3, 48.1, 48.2, 48.3, requested and displayed by the client systems 10, 20. In step S40 the consumer systems 30, 40 use the global tag sets 52.1, 52.2, 52.3, 62.1, 62.2, 62.3 related to the remote portlets 54.1, 54.2, 54.3, 64.1, 64.2, 64.3 to create a response to the requesting client systems 10, 20.

Additional tagging information related to a local portlet 34.1, 34.2, 34.3, 44.1, 44.2, 44.3 is created by the client systems 10, 20 and is used to create and/or update a local tag set 32.1, 32.2, 32.3, 42.1, 42.2, 42.3 for the local portlets 34.1, 34.2, 34.3, 44.1, 44.2, 44.3 at said consumer systems 30, 40, which are producing the local portlets 34.1, 34.2, 34.3, 44.1, 44.2, 44.3, via a standard protocol. The consumer systems 30, 40 use the local tag sets 32.1, 32.2, 32.3, 42.1, 42.2, 42.3 related to the local portlets 34.1, 34.2, 34.3, 44.1, 44.2, 44.3 to create the response to the requesting client systems 10, 20. A global tag database 52, 62 comprising a global tag set 52.1, 52.2, 52.3, 62.1, 62.2, 62.3 for each remote portlet 54.1, 54.2, 54.3, 64.1, 64.2, 64.3 produced by the producer system 50, 60 is created and/or updated at the corresponding producer system 50, 60. Further a local tag database 32, 42 comprising a local tag set 32.1, 32.2, 32.3, 42.1, 42.2, 42.3 for each local portlet 34.1, 34.2, 34.3, 44.1, 44.2, 44.3 produced by the consumer systems 30, 40 is created and/or updated at the consumer systems 30, 40. The producer systems 50, 60 and/or consumer systems 30, 40 are incorporating tag statistics into their global tag data bases 52, 62 and/or local tag databases 32, 42. Therefore the consumer systems 30, 40 are counting and aggregating tagging actions of corresponding client systems 10, 20 related to local portlets 34.1, 34.2, 34.3, 44.1, 44.2, 44.3 and/or remote portlets 54.1, 54.2, 54.3, 64.1, 64.2, 64.3. The consumer systems 30, 40 are reporting the tagging actions related to remote portlets 54.1, 54.2, 54.3, 64.1, 64.2, 64.3 to a corresponding producer system 50, 60 producing the related remote portlets 54.1, 54.2, 54.3, 64.1, 64.2, 64.3. In response, the producer systems 50, 60 return updated global tag sets 52.1, 52.2, 52.3, 62.1, 62.2, 62.3 to the consumer systems 30, 40 using the related remote portlets 54.1, 54.2, 54.3, 64.1, 64.2, 64.3. Additional the tag statistics are used to prioritize the tag information of each global tag set 52.1, 52.2, 52.3, 62.1, 62.2, 62.3 and/or each local tag set 32.1, 32.2, 32.3, 42.1, 42.2, 42.3. The consumer systems 30, 40 use the tag statistics to create a response to the client systems 10, 20, wherein tagging information of tag sets 12.1, 12.2, 12.3, 12.4, 22.1, 22.2 of related remote portlets 54.1, 64.1 and/or local portlets 34.1, 34.2, 44.2 used on portal pages 38.1, 48.2 are displayed at the client systems 10, 20 using the related remote portlets 54.1, 54.2, 54.3, 64.1, 64.2, 64.3 and/or local portlets 34.1, 34.2, 34.3, 44.1, 44.2, 44.3 according their prioritization.

In other words a consumer administrator retrieves metadata about the provided remote portlets 54.1, 54.2, 54.3, 64.1, 64.2, 64.3 of a WSRP producer system 50, 60 using a standard WSRP protocol. According to an embodiment of the present invention, the producer system 50, 60 enrich the service description/portlet description fragment of the WSRP protocol with current tag cloud information. A consumer system administrator decides to use a certain remote portlet 54.1, 54.2, 54.3, 64.1, 64.2, 64.3 and integrates it into the consumer portal. The consumer system 30, 40 retrieves the tag cloud metadata and incorporates the tag statistics into its own tagging database 32, 42. The consumer system administrator puts the remote portlet 54.1, 54.2, 54.3, 64.1, 64.2, 64.3 on a portal page 38.1, 38.2, 38.3, 48.1, 48.2, 48.3, for example a WebSphere™ portal. The consumer system administrator can also search for portlets 34.1, 34.2, 34.3, 44.1, 44.2, 44.3, 54.1, 54.2, 54.3, 64.1, 64.2, 64.3 using the tagging information. The consumer system 30, 40 displays the tag cloud or tag sets 12.1, 12.2, 12.3, 12.4, 22.1, 22.2, 32.1, 32.2, 32.3, 42.1, 42.2, 42.3, 52.1, 52.2, 52.3, 62.1, 62.2, 62.3 for that portlet on the portal pages 38.1, 38.2, 38.3, 48.1, 48.2, 48.3 for end-users. The user system 10, 20 can also use the tagging information to find certain portlets 34.1, 34.2, 34.3, 44.1, 44.2, 44.3, 54.1, 54.2, 54.3, 64.1, 64.2, 64.3. The user systems 10, 20 view and interact with the portlet, and the consumer system portal allows users to tag portlets. The Consumer systems 30, 40 count and aggregate the tagging actions of their user systems 10, 20. Additionally, the consumer systems 30, 40 send update tag information messages to WSRP producer systems 50, 60, providing the information about the tags their user systems 10, 20 made. The producer systems 50, 60 compute the new tag clouds and return the updated information back to the consumer systems 30, 40 as a response to update tag information. The consumer systems 30, 40 use the new information in their own tag engines 36, 46. This is executed on different consumer systems 30, 40, thus resulting in a distributed/collaborative tagging space.

The producer systems 50, 60 maintain metadata about their remote portlets 54.1, 54.2, 54.3, 64.1, 64.2, 64.3 in the producer system database 52, 62. It contains typically information provided with the portlet deployment descriptor and administrator made changes to titles, descriptions, etc. This metadata is extended to maintain tag cloud information for each provided remote portlets 54.1, 54.2, 54.3, 64.1, 64.2, 64.3 on a portlet descriptor basis, not a portlet entity basis. The additional metadata mainly contains a set of “tag name” and “tag count” values. The producer systems 50, 60 are free to maintain only a limited set of tag entries, e.g. top 100.

The portlet description complex type described in the WSRP specification is extended to contain a tag cloud extension. The tag cloud extension contains the above mentioned array of tag name and tag count values for each provided remote portlet 54.1, 54.2, 54.3, 64.1, 64.2, 64.3. This extension description is used to notify the consumer systems 30, 40 that the corresponding producer system 50, 60 is willing to maintain the tag cloud and that the consumer systems 30, 40 support the new operation to update and obtain tag information about a remote portlet 54.1, 54.2, 54.3, 64.1, 64.2, 64.3. The consumer systems 30, 40 are extended to understand the extension and read the tag cloud metadata. A new operation is added to the protocol, preferably by extending the WSRP portlet management port type. The new operation is named like update tag information for example. The payload of the operation contains the WSRP portlet context giving a reference to the remote portlet 54.1, 54.2, 54.3, 64.1, 64.2, 64.3 for which the tag cloud should be updated, and a tag cloud context.

The tag cloud context contains an array of tag name and tag count values. These counts denominate the tag counts added by each user tag action on the consumer side. Note that this count is a delta to the count retrieved by the consumer in a prior retrieve step.

As a result to such an update tag information call, the producer systems 50, 60 compute the new tag clouds based on their own stored tag count numbers and the passed tag cloud context. The new result is maintained in the producer system database 52, 62. The response to the update tag information is the new computed tag cloud for the corresponding remote portlet 54.1, 54.2, 54.3, 64.1, 64.2, 64.3. Based on the information, the consumer systems 30, 40 update their own tagging databases 32, 42. The consumer systems 30, 40 are extended to trigger the update tag information call in an asynchronous, regular way.

The inventive method for tagging of portlets in a portal infrastructure can be implemented as an entirely software embodiment, or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for tagging of portlets in a portal infrastructure, comprising:
receiving by at least one consumer system from at least one client system tagging information related to remote portlets produced by at least one producer system;
sending by the at least one consumer system the tagging information related to the remote portlets to the at least one producer system that produced the remote portlets, wherein the at least one producer system uses the tagging information related to the remote portlets to update global tag sets for the remote portlets;
receiving by the at least one consumer system the updated global tag sets from the at least one producer system; and
creating by the at least one consumer system a response to a request for portal pages comprising the remote portlets from the at least one client system using the received updated global tag sets.

2. The method according to claim 1, wherein the portal pages further comprise local portlets produced by the at least one consumer system, wherein the receiving by the at least one consumer system from the at least one client system the tagging information related to the remote portlets, and the creating by the at least one consumer system the response to the request for the portal pages comprising the remote portlets from the at least one client system using the updated global tag sets, comprise:
receiving by the at least one consumer system from the at least one client system tagging information related to the local portlets;
updating by the at least one consumer system local tag sets for the local portlets using the tagging information related to the local portlets; and
creating by the at least one consumer system the response to the request for the portal pages comprising the remote portlets and the local portlets using the received updated global tag sets and the updated local tag sets.

3. The method according to claim 1, wherein the sending by the at least one consumer system the tagging information related to the remote portlets to the at least one producer system that produced the remote portlets, further comprises:
updating by the at least one producer system a global tag database comprising the global tag sets for the remote portlets produced by the at least one producer system.

4. The method according to claim 2, wherein the updating by the at least one consumer system the local tag sets for the local portlets using the tagging information related to the local portlets, further comprises:
updating by the at least one consumer system a local tag database comprising the local tag sets for the local portlets produced by the at least one consumer system.

5. The method according to claim 3, wherein the updating by the at least one producer system the global tag database comprising the updated global tag sets for the remote portlets produced by the at least one producer system comprises:
receiving by the at least one producer system tag statistics related to the remote portlets produced by the at least one producer system from the at least one consumer system; and
incorporating the tag statistics related to the remote portlets produced by the at least one producer system into the global tag database by the at least one producer system.

6. The method according to claim 4, wherein the updating by the at least one consumer system the local tag database comprising the updated local tag sets for the local portlets produced by the at least one consumer system comprises:
incorporating tag statistics related to the local portlets produced by the at least one consumer system into the local tag database by the at least one consumer system.

7. The method according to claim 6, wherein the incorporating the tag statistics related to the local portlets produced by the at least one consumer system into the local tag database by the at least one consumer system comprises:
counting and aggregating tagging actions of the at least one client system related to the local portlets and the remote portlets; and
reporting the tagging actions related to the remote portlets to the at least one producer system producing the remote portlets.

8. The method according to claim 7, further comprising:
prioritizing by the consumer system the tag information of the global tag sets using the tag statistics related to the remote portlets; and
prioritizing by the consumer system the tag information of the local tag sets using the tag statistics related to the local portlets.

9. The method according to claim 8, wherein the creating by the at least one consumer system the response to the request for the portal pages comprising the remote portlets, further comprises:
creating by the at least one consumer system the response to the request for the portal pages from the at least one client system using the prioritized tag statistics related to the remote portlets and the prioritized tag statistics related to the local portlets.

10. The method according to claim 9, wherein the tagging information of the global tag sets and the local tag sets used on the portal pages are displayed at the at least one client system using the remote portlets and the local portlets according their prioritization.

11. A system for tagging of portlets in a portal infrastructure, comprising:
at least one consumer system for receiving from at least one client system tagging information related to remote portlets produced by at least one producer system, and sending the tagging information related to the remote portlets to the at least one producer system that produced the remote portlets; and
the at least one producer system for receiving from the at least one consumer system the tagging information related to the remote portlets produced by the at least one producer system, and updating global tag sets for the remote portlets using the tagging information related to the remote portlets,
wherein the at least one consumer system receives from the at least one producer system the updated global tag sets, and creates a response to a request for portal pages comprising the remote portlets from the at least one client system using the received updated global tag sets.

12. The system according to claim 11, wherein the portal pages further comprise local portlets produced by the at least one consumer system, wherein in receiving from the at least one client system the tagging information related to the remote portlets, and in creating the response to the request for the portal pages comprising the remote portlets from the at least one client system using the updated global tag sets, the at least one consumer system:
receives from the at least one client system tagging information related to the local portlets;
updates local tag sets for the local portlets using the tagging information related to the local portlets; and
creates the response to the request for the portal pages comprising the remote portlets and the local portlets using the received updated global tag sets and the updated local tag sets.

13. The system according to claim 11, wherein the at least one producer system further:
updates a global tag database comprising the global tag sets for the remote portlets produced;
receives system tag statistics related to the remote portlets produced by the at least one producer system from the at least one consumer system; and
incorporates the tag statistics related to the remote portlets produced by the at least one producer system into the global tag database.

14. The system according to claim 12, wherein in updating the local tag sets for the local portlets using the tagging information related to the local portlets, the at least one consumer system:
updates a local tag database comprising the local tag sets for the local portlets produced by the at least one consumer system; and
incorporates tag statistics related to the local portlets produced by the at least one consumer system into the local tag database.

15. The system according to claim 12, wherein the at least one producer system further prioritizes the tag information of the global tag sets using the tag statistics related to the remote portlets,
wherein the at last one consumer system further prioritizes the tag information of the local tag sets using the tag statistics related to the local portlets, and creates the response to the request for the portal pages from the at least one client system using the prioritized tag statistics related to the remote portlets and the prioritized tag statistics related to the local portlets.

16. A computer program product method for tagging of portlets in a portal infrastructure, comprising:
a computer readable storage medium having computer readable program code embodied therewith, the computer readable program code configured to:
receive from at least one client system tagging information related to remote portlets produced by at least one producer system;
send the tagging information related to the remote portlets to the at least one producer system that produced the remote portlets, wherein the at least one producer system uses the tagging information related to the remote portlets to update global tag sets for the remote portlets;
receive the updated global tag sets from the at least one producer system; and
create a response to a request for portal pages comprising the remote portlets from the at least one client system using the received updated global tag sets.

17. The computer program product according to claim 16, wherein the portal pages further comprise local portlets produced by the at least one consumer system, wherein the computer readable program code configured to receive from the at least one client system the tagging information related to the remote portlets, and create the response to the request for the portal pages comprising the remote portlets from the at least one client system using the updated global tag sets, are further configured to:
receive from the at least one client system tagging information related to the local portlets;
update local tag sets for the local portlets using the tagging information related to the local portlets; and
create the response to the request for the portal pages comprising the remote portlets and the local portlets using the received updated global tag sets and the updated local tag sets.

18. The computer program product according to claim 16, wherein the computer readable program code configured to send the tagging information related to the remote portlets to the at least one producer system that produced the remote portlets, is further configured to:
update a global tag database comprising the global tag sets for the remote portlets produced by the at least one producer system.

19. The computer program product according to claim 17, wherein the computer readable program code configured to update the local tag sets for the local portlets using the tagging information related to the local portlets, is further configured to:
update a local tag database comprising the local tag sets for the local portlets produced by the at least one consumer system.

20. The computer program product according to claim 18, wherein the computer readable program code configured to update the global tag database comprising the updated global tag sets for the remote portlets produced by the at least one producer system, is further configured to:
receive tag statistics related to the remote portlets produced by the at least one producer system from the at least one consumer system; and
incorporate the tag statistics related to the remote portlets produced by the at least one producer system into the global tag database by the at least one producer system.

21. The computer program product according to claim 19, wherein the computer readable program code configured to update the local tag database comprising the updated local tag sets for the local portlets produced by the at least one consumer system, is further configured to:
incorporate tag statistics related to the local portlets produced by the at least one consumer system into the local tag database by the at least one consumer system.

22. The computer program product according to claim 21, wherein the computer readable program code configured to incorporate the tag statistics related to the local portlets produced by the at least one consumer system into the local tag database by the at least one consumer system, is further configured to:
count and aggregate tagging actions of the at least one client system related to the local portlets and the remote portlets; and
report the tagging actions related to the remote portlets to the at least one producer system producing the remote portlets.

23. The computer program product according to claim 22, wherein the computer readable program code is further configured to:
prioritize the tag information of the global tag sets using the tag statistics related to the remote portlets; and
prioritize the tag information of the local tag sets using the tag statistics related to the local portlets.

24. The computer program product according to claim 23, wherein the computer readable program code configured to create the response to the request for the portal pages comprising the remote portlets, is further configured to:
create the response to the request for the portal pages the at least one client system using the prioritized tag statistics related to the remote portlets and the prioritized tag statistics related to the local portlets.

25. A method for tagging of portlets in a portal infrastructure, comprising:
receiving by at least one consumer system from at least one client system tagging information related to remote portlets produced by at least one producer system and tagging information related to local portlets produced by the at least one consumer system;
sending by the at least one consumer system the tagging information related to the remote portlets to the at least one producer system that produced the remote portlets, wherein the at least one producer system uses the tagging information related to the remote portlets to update global tag sets for the remote portlets;
updating by the at least one consumer system local tag sets for the local portlets using the tagging information related to the local portlets;
receiving by the at least one consumer system the updated global tag sets from the at least one producer system; and
creating by the at least one consumer system a response to a request for portal pages comprising the remote portlets and the local portlets from the at least one client system using the received updated global tag sets and the updated local tag sets.
